(19) United States
(12) Patent Application Publication
(10) Pub. No.: US 2014/0169580 A1
(43) Pub. Date: Jun. 19, 2014

(54) BROADBAND ACTIVE QUIET PILLOW

(71) Applicant: Irina Levitov, Norfolk, VA (US)

(72) Inventor: Irina Levitov, Norfolk, VA (US)

(21) Appl. No.: 14/017,737

(22) Filed: Sep. 4, 2013

Related U.S. Application Data
(60) Provisional application No. 61/696,484, filed on Sep. 4, 2012.

(51) Int. Cl. G10K 11/16

(52) U.S. Cl. CPC G10K 11/16
USPC 381/71.6

(57) ABSTRACT

An active noise cancellation system is provided in a head support to cancel noise for a supine user, lying on a bed.

### CROSS-REFERENCE TO RELATED APPLICATIONS

The present case is the utility conversion of U.S. Provisional Patent Application 61/696,484 filed Sep. 4, 2012, entitled “Active Quiet Pillow” which incorporated by reference in its entirety.

### BACKGROUND OF THE INVENTION

Active Noise Cancellation (ANC) is an acoustic technology that relies on the measurement of extraneous noise and creating a control signal that can cancel the extraneous noise at a particular point in space. These systems though complex are well understood and widely applied.

For example U.S. patent application Ser. No. 11/952,250 filed Dec. 7, 2008 discloses an electronic pillow that can abate the sounds of snoring. See also U.S. Pat. No. 5,884,996 that integrates ANC into the headboard of a bed.

In spite of theses developments there is a continuing need to develop devices with larger “sweet spots” for noise cancelation and improved comfort for users.

### SUMMARY OF THE INVENTION

In contrast to prior art designs the device of the invention incorporates both active ANC technology as well as passive sound absorption technologies that are applied to a unique “pillow” geometry. Together all of these disparate elements provide wide band noise suppression and cancelation in a portable unit that can be used in either a hospital or home setting. In general the active quiet pillow device will be used with a conventional bed. The user will lie down supine with the users head cradled in the active quiet pillow device. The device incorporates a soft comfortable foam liner covering the interior surfaces. The device contains several active speaker components under the foam that cooperate with an ANC controller to cancel sound at the users ears. The soft cushion material or “foam” supports the head with comfort and acts to attenuate noise as well. The active components are largely placed under the foam in experimentally determined locations that greatly improve the observed performance in contrast to prior devices.

### DESCRIPTION OF THE DRAWINGS

Throughout the figures of the drawing, like reference numerals indicate identical structure wherein:

FIG. 1 is a schematic cross-section of the device, and

FIG. 2 is a perspective view of the device.

### DETAILED DESCRIPTION OF THE INVENTION

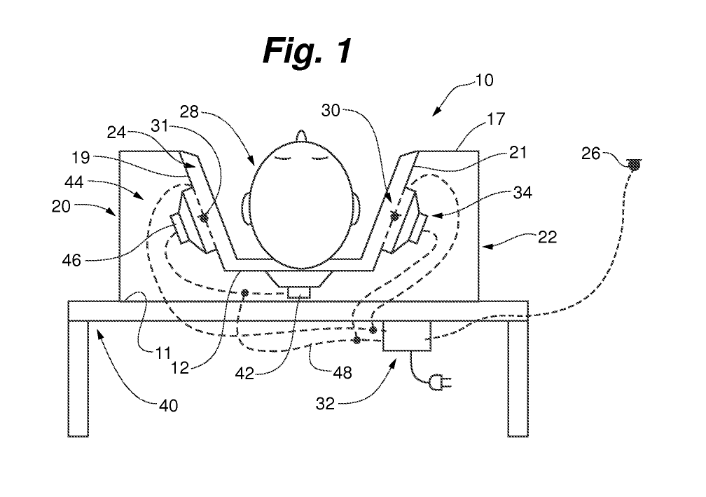

FIG. 1 shows a cross section on the device in schematic form. The active quiet pillow device 10 cradles the user's 28 head, while the user 28 is supine on bed 40. The exterior of the device is generally rectilinear comprising exterior side-wall 20 and exterior side-wall 22. Theses exterior side-walls are coupled to the exterior bottom wall 11 and the generally U-shaped top surface 17, as well as the exterior back surface 15. Together these surfaces serve to define an acoustic chamber having an acoustic volume 44 with outside dimensions of height (H) length (L) and width (W). The head rests on foam surfaces generally designated 24 in the figures, and the height dimension is tall enough to place the ears at a mid-side-wall position. However this position must be balanced with a height (H) that is not so tall as to put the side-walls into the peripheral vision of the user's eyes. It has been determined that this consideration improves comfort for many users.

The interior volume is large enough to carry a subwoofer active speaker 42 which is coupled to the ANC controller 32 output directly below the user's head, and two mid-range active speakers 34 and 46 located proximate the user's ears on the two inclined side walls. Typically the ANC control module 32 and associated wiring will be positioned within this volume 44 as well however remote location is acceptable, for example the controller may be attached to the bed 40. It is anticipated that the controller and its associated audio amplifiers will be line powered and a cord and switch will be found on the exterior surface, although not all of the wiring is shown to simplify the figures and improve clarity.

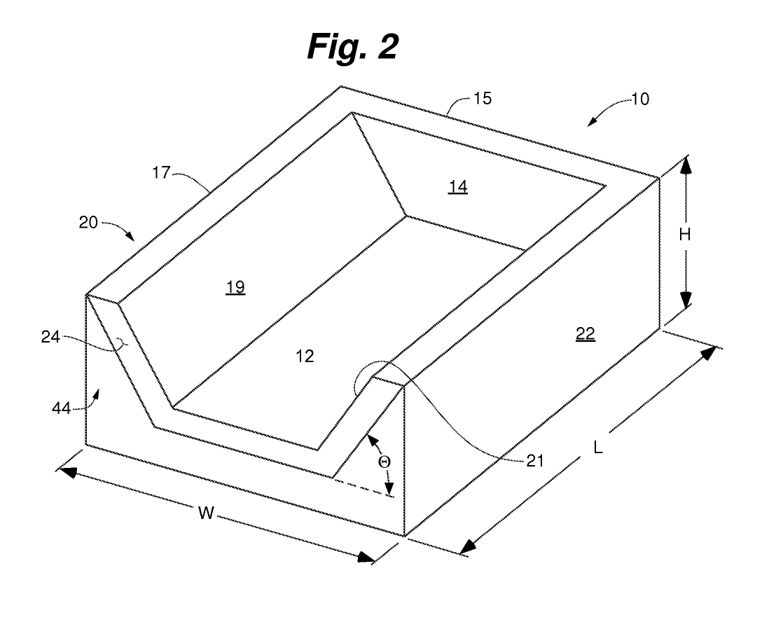

FIG. 2 shows a perspective view of the visible surfaces of the active quiet pillow device 10. By way of overview the exterior surfaces are generally rectilinear and the interior surfaces have two tapered sidewalls 19 and 21 facing the users ears. A back wall is near the crown of the user's head. The interior surfaces are covered with a soft conformal acoustic foam. The height “H” of the sidewalls is sufficient to cover the level of the ears but not so high as to be visible in the visual field of the user. Experiment has suggested that this feature reduces the sensation of claustrophobia that may otherwise be present in some users. The space between the exterior walls namely; first exterior side-wall 20, second exterior side-wall 22, exterior bottom wall 11, exterior back wall 15 and the interior walls, namely first interior side-wall 19, second interior side-wall 21, interior bottom wall 12, interior back wall 14 together define an enclosed acoustic volume generally designated 44.

An active subwoofer speaker 42 is positioned proximate the back of the user's head in the lower bottom wall of the acoustic volume. Separate first and second mid range speakers typified by speaker 34 and 46 are located in the side walls proximate the user's ears. One or more error microphones 30 maybe mounted proximate the ears as well as typified in the figure by microphone 30 and 31. The ANC controller 32 may be mounted in either the acoustic volume or exterior of the acoustic volume. A remote reference microphone designated 26 in the figure is coupled to he ANC controller. Wires 48 connect the ANC controller 32 to the various speakers and microphones. In use the ambient noise is sampled and the speakers driven to cancel the ambient sound as measured near the user's ears by microphones 30 and 31. In use the ANC system is used actively suppress noise have a characteristic frequency below about 400 Hz. Attenuation above 400 Hz is managed with the acoustic foam liner and interior geometry of the device. Together this active and passive system provides a quiet environment at the ears of the user.

What is claimed is:

1. A broadband active pillow device to support a user's head in a supine position, the user having ears and eyes, the pillow comprising:
an interior bottom panel
a first inclined side panel;
a second inclined side panel;
a back panel; that together form an interior space around said users head;
a measurement microphone located outside said space for detecting ambient noise;
a subwoofer located below said users head;
a first and second mid range speaker located in said side panels;
at least one error microphone located proximate one of said users ears;
said side walls having a height such that the wall covers said users ears but not so high as to be visible to the peripheral vision of the user's eyes;
said speakers coupled to an active noise cancellation system;
said error microphone coupled to said active noise cancellation system;
said measurement microphone coupled to said noise cancellation system whereby said cancellation system cancels noise proximate said user's ears.

2. The pillow device of claim 1, further comprising:
acoustic foam covering the surfaces of said interior space.

3. The pillow device of claim 1 wherein:
said active noise cancellation system is band pass tuned to frequencies below 400 Hz.
